(19) United States
(12) Patent Application Publication
(10) Pub. No.: US 2002/0148186 A1
(43) Pub. Date: Oct. 17, 2002

(54) Non-clogging decking

(76) Inventor: Denis W. Kasten, Novato, CA (US)

Correspondence Address: C. Robert von Hellens, CAHILL, SUTTON & THOMAS P.L.C., Suite 155, 2141 E. Highland Avenue, Phoenix, AZ, 85016, US

(21) Appl. No.: 10/105,557

(22) Filed: Mar. 25, 2002

Related U.S. Application Data
(60) Provisional application No. 60/283,004, filed on Apr. 11, 2001.

(51) Int. Cl. E06B 3/54; E04B 9/00; E04B 1/61

(52) U.S. Cl. 52/480; 52/762; 52/764; 52/582.1

(57) ABSTRACT

Boards, whether or of wood or man made materials, have downwardly converging sides in the manner of an inverted trapezoid to create a downwardly expanding space between such boards when used for decking, porches, balconies, walkways and the like. The downwardly expanding space between adjacent boards reduces the likelihood of clogging by debris and the like to which the decking, etc. is expected to be subjected.

### CROSS REFERENCE TO RELATED APPLICATIONS

The present application is related to and claims priority from a provisional application entitled “ANTI-CLOG DECK CONSTRUCTION”, filed Apr. 11, 2001 and assigned Serial No. 60/283,004, which application describes an invention by the present inventor.

### BACKGROUND OF THE INVENTION

1. Field of the Invention

The present invention relates to decks, porches, balconies and elevated walkways and, more particularly, to a non-clogging feature to prevent build-up of debris between boards forming such decks, porches, balconies or walkways.

2. Description of Related Art

Conventional decks, porches, balconies and elevated walkways are formed of boards rectangular in cross section and disposed in spaced relationship with respect to one another. The spaces between the boards are intended for purposes of providing ventilation therethrough and to permit debris to fall therethrough and prevent build-up on the boards. Furthermore, the use of a stream of water under pressure to wash/scrub the boards is facilitated by the water and entrained debris dropping through the spaces. If the spaces are relatively wide, passage of debris therethrough is facilitated but a safety hazard may be created if a user's foot or shoe catches in such a space and causes the user to trip and fall. If the spaces are sufficiently narrow to avoid being a safety hazard, debris, such as leaves, tend to collect therein due to frictional resistance provided by the edges of the adjacent boards. The trapped leaves may, in turn, collect small rocks, soil and other debris. With intermittent wetting due to rain or other source of water, the trapped debris will tend to become compacted due to the weight of the debris, pressure exerted thereon by a user's feet/shoes and expansion/contraction of the boards as a function of temperature excursions and the temperature coefficient of the boards. Often, efforts to expunge compacted debris by use of a tool to force the debris downwardly through the spaces will often exacerbate the problem by further compacting the debris.

### SUMMARY OF THE INVENTION

The present invention is directed to the configuration of boards of natural or man made materials used for decking, porches, balconies and walkways which tends to retain clear the space between the boards. More particularly, the lateral cross section of each board generally defines an inverted trapezoid. Thereby, the space between the boards increases in width from top to bottom and any debris entering the top of the space will fall therethrough essentially without any impediment by the sides of the opposed boards.

### BRIEF DESCRIPTION OF THE DRAWINGS

The present invention will be described with greater specificity and clarity with reference to the following drawings, in which:

FIG. 1 is a representative view of an elevated walkway and is representative of like constructed decks, porches and balconies;

FIG. 2 is a cross sectional view of prior art boards used to form a decking or a walkway;

FIG. 3 is a partial cross sectional view illustrating the space between the conventional boards shown in FIG. 2;

FIG. 4 is a cross sectional view illustrating boards constructed in accordance with the present invention;

FIG. 5 illustrates a variant of the boards shown in FIG. 4; and

FIG. 6 is a cross sectional view illustrating the space between adjacent boards shown in FIG. 4.

### DESCRIPTION OF THE PREFERRED EMBODIMENT

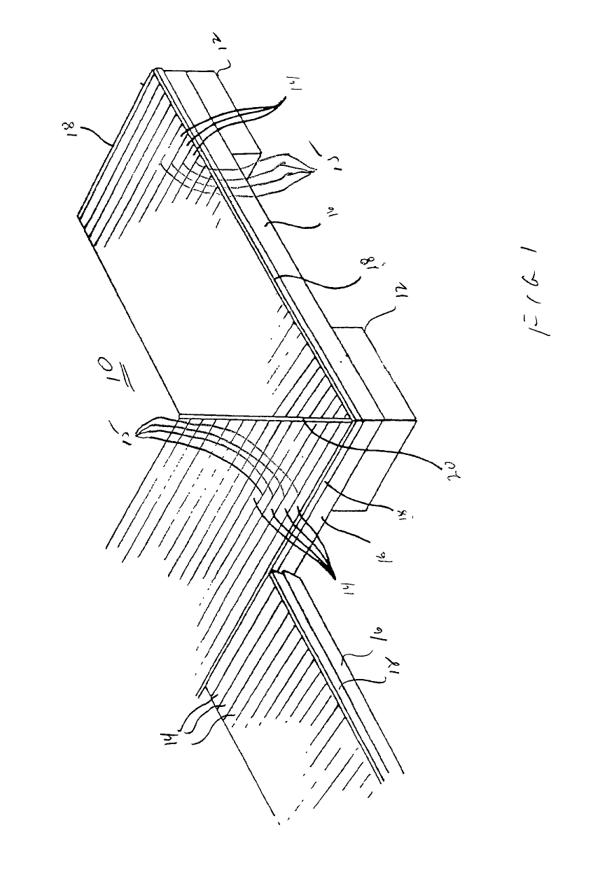

Referring to FIG. 1, there is shown an elevated walkway 10. The walkway is supported upon a plurality of pillars 12 or the like. It is to be understood that this walkway is representative of similar structure useable on decks, porches, balconies, etc. Typically, the walkway includes a plurality of boards 14 aligned adjacent one another with a discrete space 15 therebetween. The boards are generally supported upon a plurality of joists 16 forming a support structure for boards 14. As depicted, these joists rest upon pillars 12 or the like. The lateral sides of walkway 10 may include edge pieces 18 for ornamental purposes or to protect the ends of boards 14. At a junction of one set of boards of the walkway with another set of boards of the walkway, a spacer 20 may be employed. At an end of walkway 10, a further edge piece 18 may be lodged for functional or ornamental purposes.

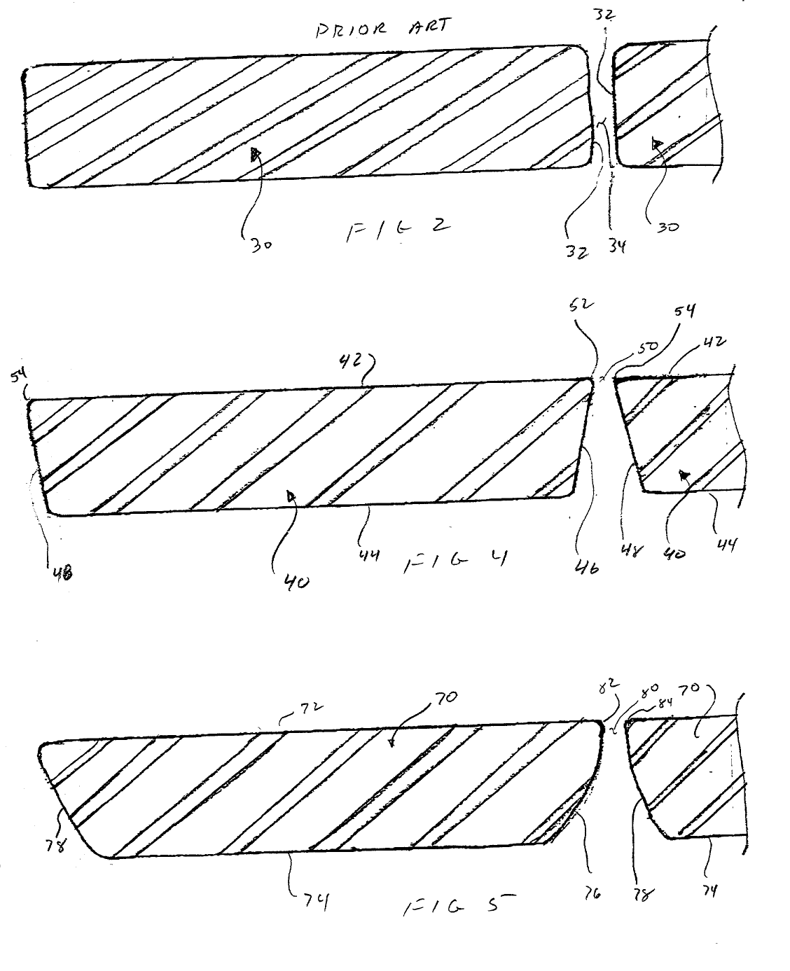

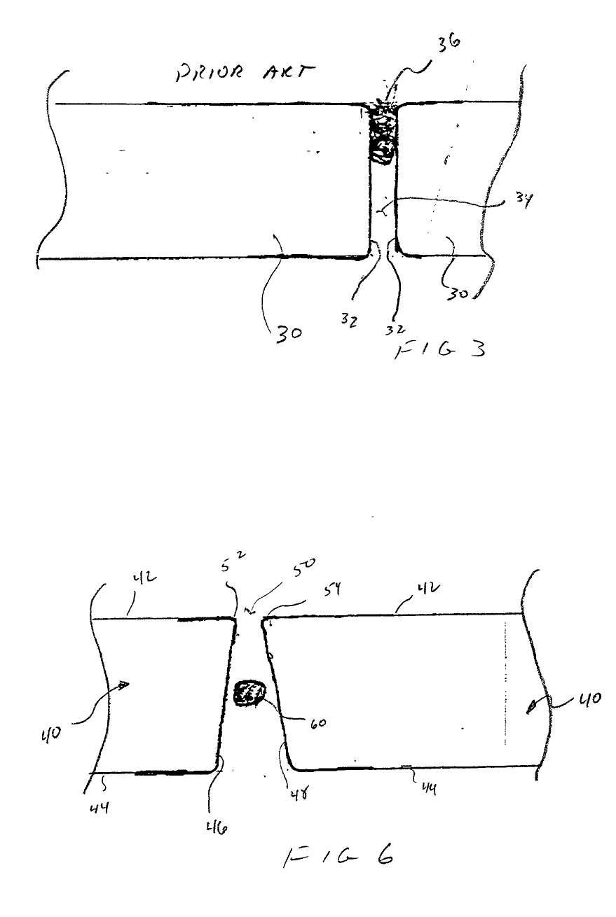

Conventionally, the boards used for walkways, decks, porches, balconies, etc. are boards 30 shown in FIG. 2, which boards have a rectangular lateral cross section, as illustrated. These boards are typically of wood and either impregnated for weather resistivity or have a protective coating of an oil based material, shellac, etc. Longitudinal edges 32 of adjacent boards 30 are spaced apart from one another, primarily for the purpose of accommodating drainage as a result of rainfall. Typically, space 34 between the boards is on the order of a quarter inch and sufficient to provide drainage therethrough and passage of small sized debris. However, leaves, twigs and other vegetation often drains into, falls into or is pushed into space 34 between boards 30, as illustrated in FIG. 3. Such debris 36 tends to become clogged in space 34. As other even small sized debris is added, the initial vegetative clog tends to become compacted. As a result, drainage of water is impeded. Additionally, bacteria may colonize and result in degradation or deterioration of the adjacent material of boards 30. Insects may also infest the clogs and breed. Thus, not only are the clogs impediments to the functions of space 34 but they may cause secondary destructive effects.

FIG. 4 illustrates a board 40 suitable for use in walkways, decks, porches, balconies, etc., of the type shown in FIG. 1. Boards 40 have a lateral cross section like the configuration of an inverted trapezoid. That is, the lateral width of top surface 42 is greater than the lateral width of bottom surface 44, as illustrated in FIG. 4. This results in a downward inward or converging slope of sides 46, 48. Upon spacing boards 40, upon decking, etc., in a spaced apart relationship to other longitudinally adjacent boards 40, a space or gap 50 is provided between top edges 52, 54 of adjacent boards. Because of the downwardly diverging sides 46, 48 the width of space or gap 50 between the opposing sides of adjacent boards expands downwardly, as illustrated.

Such downward expansion, as particularly shown in FIG. 6, tends to reduce retention by sides 46, 48 on any debris 60 introduced into gap/space 50 intermediate edges 52, 54. That is, either the debris will drop straight through or, if caught intermediate edges 52, 54 will be readily downwardly conveyed in response to the slightest force of wind, water or physical contact. Thereby, one may conclude that decking, etc., constructed of adjacently positioned spaced apart boards 40 constructed in accordance with the present invention has a self cleaning feature which retains the space between the boards free and clear of debris.

FIG. 5 illustrates a variant lateral cross sectional configuration, as representatively shown by board 70. Herein, top surface 72 is wider than bottom surface 74. Sides 76, 78 may be curved, as illustrated, rather than essentially planar as shown in FIG. 4. This configuration has aesthetic value and also provides for exponential expansion of gap or space 80 between the opening longitudinal sides of adjacent boards. It is to be understood that other configurations, such as a segmented step configuration or multiple longitudinal flat surfaces set at an angle with respect to one another could be employed. Similarly, sides 76, 78 could be convex-like instead of concave-like, as shown in FIG. 5.

Traditionally, the boards for decking, etc. are of treated or untreated wood. With the expense of good quality lumber increasing continuously, the use thereof has certain fiscal constraints. With the advancing technology for producing various products of man made materials, such products, on a per unit basis, have become less and less expensive although initial costs of creating and making molds, and related pre-production efforts, are of significant expense. It is therefore contemplated that boards 40, 70 can be economically produced from man made materials. Such boards may be of solid material but more likely manufactured with a foam core surrounded by a sheath. Alternatively, the boards may be hollow with or without supporting webbing for structural purposes. Other manufacturing processes, whether known or unknown, could be employed to produce boards 40, 70 of man made materials. Such boards of man made materials and of appropriate chemical composition or with protective coatings, will withstand the destructive effects of weather and solar irradiation.

While the invention has been described with reference to several particular embodiments thereof, those skilled in the art will be able to make the various modifications to the described embodiments of the invention without departing from the true spirit and scope of the invention. It is intended that all combinations of elements and steps which perform substantially the same function in substantially the same way to achieve the same result are within the scope of the invention.

I claim:

1. A board for use in decking, porches, balconies or walkways, said board comprising in combination:
a) a top surface having a first lateral width;
b) a bottom surface having a second lateral width wherein said first lateral width is greater than said second lateral width to define downwardly converging sides of said board, whereby the space between adjacent ones of said boards forming a surface of such decking, porches, balconies or walkways expands laterally downwardly.

2. A board as set forth in claim 1 wherein said board is of man made materials.

3. A board as set forth in claim 1 wherein said board includes wood as a material.

4. A board as set forth in claim 1 wherein said sides are essentially planar.

5. A board as set forth in claim 1 wherein said sides are not essentially planar.

6. Decking, porches, balconies and walkways having a top surface constructed from a plurality of boards placed side by side and spaced apart from one another, each of said boards comprising in combination:
a) a top surface having a first lateral width;
b) a bottom surface having a second lateral width wherein said first lateral width is greater than said second lateral width to define downwardly converging sides of said board, whereby, the space between adjacent ones of said boards diverges downwardly.

7. Decking, porches, balconies and walkways as set forth in claim 6 wherein said board is of man made materials.

8. Decking, porches, balconies and walkways as set forth in claim 6 wherein said board includes wood as a material.

9. Decking, porches, balconies and walkways as set forth in claim 6 wherein said sides are essentially planar.

10. Decking, porches, balconies and walkways as set forth in claim 6 wherein said sides are not essentially planar.

11. An anti-clog construction for decking, porches, balconies and walkways, said construction comprising in combination:
a) a plurality of boards, each of said boards having longitudinal sides, top surfaces and bottom surfaces;
b) a plurality of joists for supporting said boards in alignment with and spaced apart from one another;
c) each board of said plurality of boards having a first lateral width for said top surface and defining the top edges of said longitudinal sides, a second lateral width for said bottom surface and defining the bottom edges of said longitudinal sides, first lateral width being greater than said second lateral width; and
d) said longitudinal sides being adapted to converge downwardly; whereby, the space between said aligned boards diverges downwardly.

12. An anti-clog construction as set forth in claim 11 wherein each of said boards is of man made materials.

13. An anti-clog construction as set forth in claim 11 wherein said boards include wood as a material.

14. An anti-clog construction as set forth in claim 11 wherein said sides are essentially planar.

15. An anti-clog construction as set forth in claim 11 wherein said sides are not essentially planar.
